(19) United States
(12) Patent Application Publication
(10) Pub. No.: US 2025/0190162 A1
(43) Pub. Date: Jun. 12, 2025

(54) DISPLAY SYSTEM AND DISPLAY METHOD

(71) Applicant: Optoma Corporation, New Taipei City (TW)

(72) Inventors: Chia-Wen Chang, New Taipei City (TW); Yen-Hsiang Hung, New Taipei City (TW)

(73) Assignee: Optoma Corporation, New Taipei City (TW)

(21) Appl. No.: 18/945,530

(22) Filed: Nov. 13, 2024

(30) Foreign Application Priority Data
Dec. 8, 2023 (TW) 112147815

(51) Int. Cl. G06F 3/14

(52) U.S. Cl. CPC G06F 3/1446

(57) ABSTRACT

A display system and a display method are provided. The display system includes a first display device, a first transmission cable and a second display device. The first transmission cable connects between the first display device and the second display device. The first display device receives a first command and an image signal. The first display device generates a first control signal according to the first command. A splicing mode of the first display device is turned on, the first display device provides the first control signal and the image signal to the second display device. The first display device displays a first image. The second display device displays a second image. A predetermined displaying image corresponding to the image signal comprises the first image and the second image.

### CROSS-REFERENCE TO RELATED APPLICATION

This application claims the priority benefit of Taiwan application serial no. 112147815, filed on Dec. 8, 2023. The entirety of the above-mentioned patent application is hereby incorporated by reference herein and made a portion of this specification.

### BACKGROUND

### Technical Field

The disclosure relates to a display system and a display method applied to the display system.

### Description of Related Art

A display system with multiple display devices connected to each other have gradually become the mainstream application system in many situations, such as in indoor conference rooms, subways, and airports, where it serves as an advertising wall or information display screen When the display system displays a spliced image, it is necessary to establish a control cable and an image signal transmission cable between each display device to respectively control the display operations of each display device and to respectively transmit different image signals to each display device, therefore the process of controlling and setting the display system is cumbersome.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

A display system and a display method, which may provide simple hardware configuration and control method, and simplify the process of displaying spliced images, are provided in the disclosure. The disclosure uses one signal cable to achieve the effect of transmitting control signals and the same image signal between multiple display devices. The other objectives and advantages of the disclosure may be further understood from the descriptive features disclosed in the disclosure.

In order to achieve one of, or portions of, or all of the above objectives or other objectives, an embodiment of the disclosure provides a first display device, a second display device, and a first transmission cable. The first display device includes a first image and command processing device, a first image input terminal, a first displayer, and a first image output terminal. The second display device includes a second image and command processing device, a second image input terminal, a second displayer, and a second image output terminal. The first image and command processing device is configured to generate a first control signal. The first image input terminal is configured to receive an image signal, in which the image signal corresponds to a predetermined displaying image. The first image output terminal is configured to output the image signal and the first control signal, in which the first image and command processing device is electrically connected to the first image input terminal, the first displayer, and the first image output terminal. The first transmission cable is configured to transmit the image signal and the first control signal from the first display device to the second display device. The second image input terminal is connected to the first image output terminal through the first transmission cable and is configured to receive the image signal and the first control signal. The second image and command processing device is electrically connected to the second image input terminal and the second image output terminal. The first display device is configured to display a window interface. A splicing mode of the window interface is selected to be turned on so as to generate a first command by the first display device. The first display device is configured to generate the first control signal according to the first command and transmit first control signal to the second display device. The first displayer of the first display device is configured to display the first image and the second displayer of the second display device is configured to display the second image. The predetermined displaying image comprises the first image and the second image.

In an embodiment of the disclosure, the first control signal is a signal that complies with a control function of a consumer electronic product under a high definition multimedia interface.

In an embodiment of the disclosure, the first control signal is a vendor-specific payload or a reserved field packaged in auxiliary video information of a high definition multimedia interface.

In an embodiment of the disclosure, when the first image and command processing device is configured to analyze that the first command corresponds to a serial number operation code, the first image and command processing device is configured to set a serial number of the first display device using a first serial number, and the first image and command processing device is configured to provide the first serial number and the serial number operation code to the first image output terminal. The first image output terminal is configured to package the first serial number and the serial number operation code into the first control signal. When the second image and command processing device analyzes that the first control signal includes the serial number operation code, the second image and command processing device is configured to set a serial number of the second display device by incrementing the first serial number to the second serial number.

In an embodiment of the disclosure, the display system also includes a third display device connected in series to the second display device. The second image and command processing device is configured to provide the second serial number and the serial number operation code to the second image output terminal. The second image output terminal is configured to package the second serial number and the serial number operation code into a second control signal and provide the second control signal to the third display device, so that the third display device is configured to sequentially increment the second serial number to the third serial number according to the second serial number and the serial number operation code to set a serial number of the third display device.

In an embodiment of the disclosure, the first display device further includes a first storage, the second display device further includes a second storage. When the first image and command processing device analyzes that the first command corresponds to a splicing mode operation code, the first image and command processing device is configured to further analyze and store a splicing mode number carried by the first command in the first storage, and the first image and command processing device is configured to provide the splicing mode operation code and the splicing mode number to the first image output terminal. The first image output terminal is configured to package the splicing mode operation code and the splicing mode number into the first control signal and provide the first control signal to the second display device. After the second display device analyzes that the first control signal corresponds to the splicing mode operation code, the second image and command processing device is configured to store the splicing mode number in the second storage.

In an embodiment of the disclosure, the display system also includes the third display device connected in series to the second display device. The third display device further includes a third storage. The second image and command processing device is configured to control the second image output terminal to transmit the first control signal as the second control signal to the third display device, so that the third display device stores the splicing mode number in the third storage.

In an embodiment of the disclosure, when the first image and command processing device analyzes that splicing position number operation code corresponds to the first command, the first image and command processing device is configured to set a splicing position number of the first display device using a first splicing position number. The first image and command processing device is configured to generate a second splicing position number corresponding to the second display device. The first image and command processing device is configured to package the splicing position number operation code and the second splicing position number into the first control signal. After the second display device analyzes that the first control signal corresponds to the splicing position number operation code, the second image and command processing device is configured to store the splicing position number operation code in the second storage.

In an embodiment of the disclosure, the display system also includes the third display device sequentially connected in series to the first display device and the second display device. The first image and command processing device is configured to further generate a third splicing position number corresponding to the third display device. The first image and command processing device is configured to package the splicing position number operation code and the third splicing position number into the first control signal, and provides the first control signal to the second display device. When the second display device analyzes that a target address carried by the first control signal does not match the serial number of the second display device, the first control signal serves as the second control signal and is transmitted onwards to the third display device, so that the splicing position number of the third display device is set to the third splicing position number.

In an embodiment of the disclosure, the first image and command processing device is configured to cut the image signal into multiple sub-image signals according to the splicing mode number, and select one of the sub-image signals according to the first splicing position number, so that the first displayer displays the first image. The second image and command processing device is configured to cut the image signal into multiple sub-image signals according to the splicing mode number, and select a corresponding one of the sub-image signals according to the second splicing position number, so that the second displayer displays the second image.

The display method of the disclosure is suitable for a display system. The display system includes a first display device, a first transmission cable, and a second display device. The display method includes the following steps of operation. A window interface is displayed through the first display device. A splicing mode of the window interface is selected to be turned on for generating a first command. The first command is analyzed through the first image and command processing device of the first display device to generate a first control signal. The image signal is received through the first image input terminal of the first display device. The first image is generated according to the first control signal and the image signal through the first image and command processing device of the first display device. The image signal and the first control signal are output through the first image output terminal of the first display device. The image signal and the first control signal are received through the second image input terminal of the second display device via the first transmission cable. The second image is generated according to the first control signal and the image signal through the second image and command processing device of the second display device. The first image is displayed through the first displayer of the first display device and the second image is displayed through the second displayer of the second display device, wherein a predetermined displaying image corresponding to the image signal comprises the first image and the second image.

In an embodiment of the disclosure, wherein when the first image and command processing device analyzes that the first command corresponds to serial number operation code, the first image and command processing device sets a serial number of the first display device using a first serial number, wherein the first image and command processing device provides the first serial number and the serial number operation code to the first image output terminal, the first image output terminal packages the first serial number and the serial number operation code into the first control signal. Wherein when the second image and command processing device analyzes that the first control signal comprises the serial number operation code, the second image and command processing device sets a serial number of the second display device by incrementing the first serial number to the second serial number.

In an embodiment of the disclosure, the display system further comprises a third display device connected in series to the second display device, the display method further comprises: providing the second serial number and the serial number operation code to the second image output terminal through the second image and command processing device, wherein the second image output terminal packages the second serial number and the serial number operation code into a second control signal and provides the second control signal to the third display device, so that the third display device sequentially increments the second serial number to the third serial number according to the second serial number and the serial number operation code to set a serial number of the third display device.

In an embodiment of the disclosure, wherein the first display device comprises a first storage, the second display device comprises a second storage, wherein when the first image and command processing device analyzes that the first command corresponds to splicing mode operation code, the first image and command processing device further analyzes and stores a splicing mode number carried by the first command in the first storage, wherein the first image and command processing device provides the splicing mode operation code and the splicing mode number to the first image output terminal, the first image output terminal packages the splicing mode operation code and the splicing mode number into the first control signal and provides the first control signal to the second display device, and wherein after analyzing that the first control signal corresponds to the splicing mode operation code through the second display device, the second image and command processing device stores the splicing mode number in the second storage.

In an embodiment of the disclosure, the display system further comprises the third display device connected in series to the second display device. The third display device comprises a third storage. The display method further comprises: controlling the second image output terminal to transmit the first control signal as the second control signal to the third display device through the second image and command processing device, so that the third display device stores the splicing mode number in the third storage.

In an embodiment of the disclosure, wherein when the first image and command processing device analyzes that the first command corresponds to splicing position number operation code, the first image and command processing device sets a splicing position number of the first display device using a first splicing position number, wherein the first image and command processing device generates a second splicing position number corresponding to the second display device, the first image and command processing device packages the splicing position number operation code and the second splicing position number into the first control signal, and after the second display device analyzes that the first control signal corresponds to the splicing position number operation code, the second image and command processing device stores the splicing position number operation code in the second storage.

In an embodiment of the disclosure, the display system further comprises the third display device sequentially connected in series to the first display device and the second display device, the display method further comprises: further generating a third splicing position number corresponding to the third display device through the first image and command processing device, packaging the splicing position number operation code and the third splicing position number into the first control signal through the first image and command processing device, and providing the first control signal to the second display device, and wherein when the second display device analyzes that a target address carried by the first control signal does not match a serial number of the second display device, the first control signal serves as the second control signal and is transmitted onwards to the third display device, so that the splicing position number of the third display device is set to the third splicing position number.

In an embodiment of the disclosure, the display method further comprises: cutting the image signal into a plurality of sub-image signals according to the splicing mode number and selecting one of the sub-image signals according to the first splicing position number through the first image and command processing device, displaying the first image through the first displayer; and cutting the image signal into the sub-image signals according to the splicing mode number and selecting a corresponding one of the sub-image signals according to the second splicing position number through the second image and command processing device, displaying the second image through the second displayer.

Based on the above, the display system and display method of the disclosure may transmit control signals and image signals to other display devices through the first display device, thereby simplifying the hardware configuration and the process of the display method of the overall display system in displaying the predetermined displaying image.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

FIG. 1A is a block schematic diagram of a display system of an embodiment of the disclosure.

FIG. 1B is a device block schematic diagram of a first display device of an embodiment of the disclosure.

FIG. 1C is a device block schematic diagram of a second display device of an embodiment of the disclosure.

FIG. 2A is a schematic diagram of the functional hierarchy of a window interface displayed on a screen of an embodiment of the disclosure.

FIG. 2B to FIG. 2D are schematic diagrams of multiple levels in a window interface displayed on a screen of an embodiment of the disclosure.

FIG. 3A is a flowchart of a display method of an embodiment of the disclosure.

FIG. 3B is a flowchart of a display method of an embodiment of the disclosure.

FIG. 3C is a detailed flowchart of step S31 in FIG. 3B.

FIG. 3D is a detailed flowchart of step S31 in FIG. 3B.

FIG. 3E is a detailed flowchart of step S31 in FIG. 3B.

FIG. 3F is a detailed flowchart of step S31 in FIG. 3B.

FIG. 4 is a schematic diagram of fields of a control signal of an embodiment of the disclosure.

FIG. 5A illustrates a control signal carrying serial number operation code of an embodiment of the disclosure.

FIG. 5B is a schematic diagram illustrating a control signal carrying splicing mode operation code of an embodiment of the disclosure.

FIG. 5C is a schematic diagram illustrating a first control signal carrying splicing position number operation code of an embodiment of the disclosure.

FIG. 6 is a schematic diagram of a table of second operation code of an embodiment of the disclosure.

FIG. 7A and FIG. 7B are schematic diagrams of a display system displaying a predetermined displaying image of an embodiment of the disclosure.

FIG. 8A is a schematic diagram of a table of InfoFrame code of an embodiment of the disclosure.

FIG. 8B is a schematic diagram of a table of each field in a VSIF of an embodiment of the disclosure.

### DETAILED DESCRIPTION OF DISCLOSED EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The above and other technical contents, features and effects of the disclosure will be clear from the below detailed description of an embodiment of the disclosure with reference to accompanying drawings. The directional terms mentioned in the embodiments below, like “above”, “below”, “left”, “right”, “front”, and “back”, refer to the directions in the appended drawings. Therefore, the directional terms are used to illustrate rather than limit the disclosure.

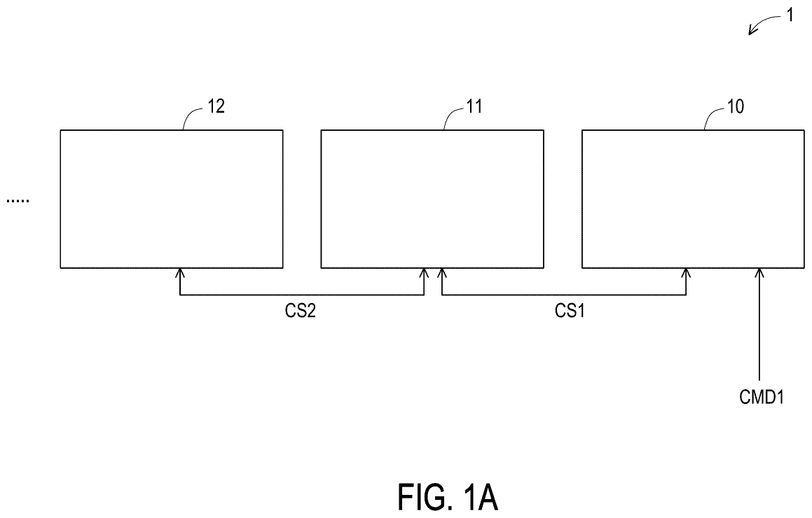

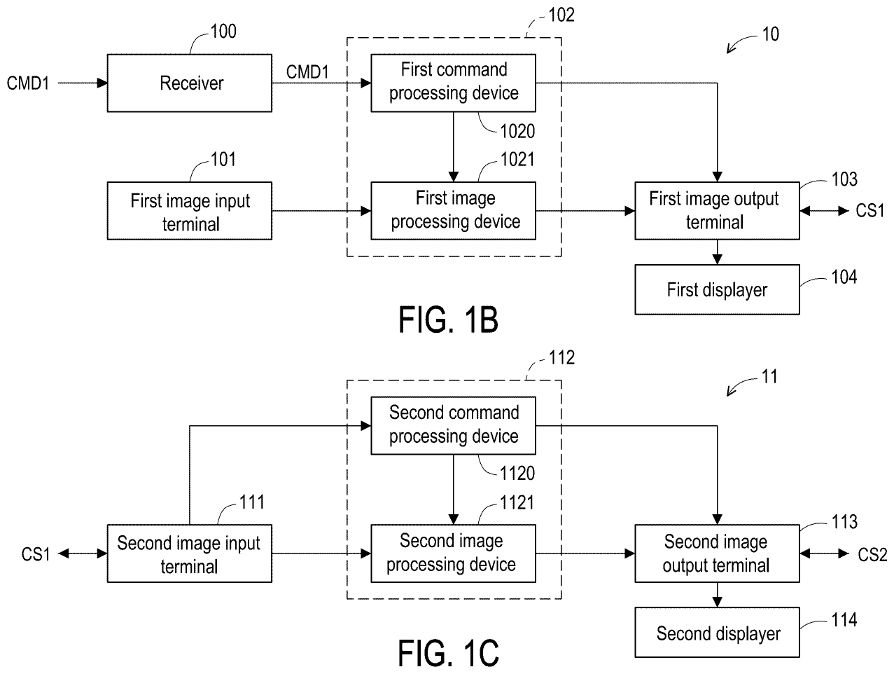

FIG. 1A is a block schematic diagram of a display system of an embodiment of the disclosure. The display system 1 includes a first display device 10, a second display device 11, and a third display device 12. The display system 1 may be a splicing image system for displaying a displaying image. The displaying image is a complete image, and the first display device 10 to the third display device 12 and other display devices may each display a portion of the displaying image. In one embodiment, the display system 1 may be a splicing image system. The display system 1 is configured to display a predetermined displaying image, and the display system 1 includes a first display device 10 and a second display device 11. The first display device 10 and the second display device 11 may each display a portion of the predetermined displaying image. Each display device of the display system 1 may be electrically connected through a high definition multimedia interface (HDMI) signal cable. For example, the first display device 10 and the second display device 11, as well as the second display device 11 and the third display device 12, may be interconnected in series via an HDMI signal cable to form a list. The list refers to the arrangement order of the display devices in the display system 1. In the list, the first display device 10 serves as the master display device, which may receive the first command CMD1. Subsequently, the first display device 10 respectively provides the first control signal CS1 and the second control signal CS2 via the HDMI signal cable to set the slave display devices, specifically the second display device 11 and the third display device 12, so that each display device in the list may display a correct portion of the predetermined displaying image according to the control signal, thereby enabling the display system 1 to display a complete predetermined displaying image. Therefore, each display device (e.g., the first display device 10, the second display device 11, and the third display device 12) of the display system 1 is only connected with an HDMI signal cable, and the hardware settings of the display system 1 may be completed through a relatively simple hardware connection method.

FIG. 1B is a device block schematic diagram of a first display device of an embodiment of the disclosure. The first display device 10 includes a receiver 100, a first image input terminal 101, a first image and command processing device 102, and a first image output terminal 103. The receiver 100, the first image input terminal 101, and the first image output terminal 103 are respectively electrically connected to the first image and command processing device 102. In one embodiment, the receiver 100 may be configured to receive the first command CMD1 provided externally. The receiver 100 is, for example, an infrared receiver that may receive signals provided by a remote controller operated by a user. To further explain, the user operates the on-screen display (OSD) of the first display device 10 through a remote controller to generate the first command CMD1 and provide the first command CMD1 to the first image and command processing device 102. For example, a splicing mode of the window interface is selected to be turned on so as to generate the first command. The first image input terminal 101 may be configured to receive an image signal corresponding to a predetermined displaying image provided by an external image source. In addition, an external image source (not displayed), such as a laptop or USB storage device, provides image signals corresponding to the predetermined displaying image to the first display device 10 via wireless or wired means. The first image and command processing device 102 is electrically connected to the receiver 100 and the first image input terminal 101. Specifically, the first image and command processing device 102 includes a first command processing device 1020 and a first image processing device 1021. The first image processing device 1021 is electrically connected to the first image input terminal 101, the first image input terminal 101 receives an image signal provided by an external image source, and the first image input terminal 101 provides the image signal to the first image processing device 1021. The first command processing device 1020 is electrically connected to the receiver 100 and the first image processing device 1021. The first command processing device 1020 may analyze the received first command CMD1. Furthermore, the first command processing device 1020 may decode the first command CMD1 and generate operation code corresponding to the first command CMD1. The first command processing device 1020 provides operation code corresponding to the first command CMD1 to the first image processing device 1021. To further explain, the first command processing device 1020 is configured to receive the first command CMD1, analyze the first command CMD1, and generate operation code corresponding to the first command CMD1 by programming at least one of the CEC signal and HDMI auxiliary video information type of HDMI. The first image processing device 1021 cuts multiple sub-image signals from the image signal according to the operation code corresponding to the first command CMD1 and selects one of the sub-image signals. The first image output terminal 103 provides the selected sub-image signal to the first displayer 104 of the first display device 10. The first displayer 104 is electrically connected to the first image output terminal 103 for displaying a portion of the predetermined displaying image. In addition, the first image output terminal 103 receives the operation code corresponding to the first command CMD1 provided by the first command processing device 1020 and the image signal provided by the first image processing device 1021, and packages the operation code corresponding to the first command CMD1 into the first control signal CS1. The first control signal CS1 is transmitted to the next one in the list, that is, the second display device 11, and the first image output terminal 103 provides the image signal to the second display device 11. Both the first display device 10 and the second display device 11 have the same image signal. Specifically, the first image output terminal 103 provides the first control signal CS1 and the image signal to the second display device 11 through the HDMI signal cable.

The first image input terminal 101 and the first image output terminal 103 are, for example, at least one circuit of the HDMI interface, at least one chip of the HDMI interface, an integrated circuit or at least one chip set of the HDMI interface. The first image and command processing device 102 is, for example, at least one processor, at least one central processing unit (CPU), a graphics processing unit (GPU), other programmable general-purpose or special-purpose microprocessor, a digital signal processor (DSP), a programmable controller, an application specific integrated circuit (ASIC), a programmable logic device (PLD), other at least one of other similar processing chip or circuit, or a combination of these devices. The first command processing device 1020 is, for example, at least one processor, at least one central processing unit (CPU), a graphics processing unit (GPU), other programmable general-purpose or special-purpose microprocessor, a digital signal processor (DSP), a programmable controller, an application specific integrated circuit (ASIC), a programmable logic device (PLD), other at least one of other similar processing chip or circuit, or a combination of these devices. The first image processing device 1021 is, for example, at least one processor, at least one central processing unit (CPU), a graphics processing unit (GPU), other programmable general-purpose or special-purpose microprocessor, a digital signal processor (DSP), a programmable controller, an application specific integrated circuit (ASIC), a programmable logic device (PLD), other at least one of other similar processing chip or circuit, or a combination of these devices. The first displayer 104 of the first display device 10 is, for example, light-emitting diode (LED) displayers, organic light-emitting diode (OLED) displayers, plasma display panel (PDP) displayers, light-emitting diode

(LED) panels, or organic light-emitting diode (OLED) panels, etc. Each display device (10, 11, 12 . . . ) of the display system 1 also includes a storage (e.g., removable random access memory, flash memory, or hard disk), and the storage is electrically connected to the image and command processing device of the display device. The operation code mentioned in this article belongs to the program code. For example, the custom operation code in this disclosure may be freely set by the display device manufacturer or the user. The custom operation codes are, for example, the operation code of the first command CMD1 in this disclosure, the operation code of the first control signal CS1, the serial number operation code, the splicing mode operation code, the splicing position number operation code, etc. After analyzing of the operation codes through the command processing devices of the display device (e.g., the first command processing device 1020 and the second command processing device 1120), the command processing devices provide the operation codes to the image processing devices (e.g., the first image processing device 1021 and the second image processing device 1121) for execution.

FIG. 1C is a device block schematic diagram of a second display device of an embodiment of the disclosure. In some embodiments, the second display device 11 and the third display device 12 may have the same device structure. Therefore, regarding the structure of the third display device 12, reference may also be made to the following description of the second display device 11. Overall, the second display device 11 is similar to the first display device 10. The difference between the two is that the first display device 10 receives the first command CMD1 through the receiver 100, and the second display device 11 does not receive the first command CMD1. Therefore, the second display device 11 does not require a receiver or additional cables to receive control signals. In this embodiment, the image signal may be transmitted through the HDMI signal cable while simultaneously transmitting the first control signal CS1. Consequently, the burden of setting up additional hardware cables to transmit the first control signal CS1 is eliminated.

Specifically, the second display device 11 includes a second image input terminal 111, a second image and command processing device 112, and a second image output terminal 113. The second image input terminal 111 may be configured to receive the image signal and the first control signal CS1. The second image and command processing device 112 is electrically connected to the second image input terminal 111. Specifically, the second image and command processing device 112 includes a second command processing device 1120 and a second image processing device 1121. The second image processing device 1121 is electrically connected to the second image input terminal 111, and the second image input terminal 111 obtains the image signal and the first control signal CS1 from the first display device 10. The second image input terminal 111 provides the image signal to the second image processing device 1121. The second command processing device 1120 is electrically connected to the second image processing device 1121 to receive the first control signal CS1 from the second image input terminal 111 and analyze the first control signal CS1. After the second command processing device 1120 analyzes and determines the operation code of the first control signal CS1, the second command processing device 1120 provides the operation code corresponding to the first control signal CS1 to the second image processing device 1121. The second image processing device 1121 may cut multiple sub-image signals from the image signal according to the operation code corresponding to the first control signal CS1 and select one of the sub-image signals, but this selected sub-image signal is not the sub-image signal selected by the first image processing device 1021 of the first display device 10. Finally, the second image output terminal 113 provides the selected sub-image signal to the second displayer 114 of the second display device 11. The second displayer 114 is electrically connected to the second image output terminal 113 for displaying a portion of the predetermined displaying image. The second image output terminal 113 receives the operation code corresponding to the first control signal CS1 provided by the second command processing device 1120 and the image signal provided by the second image processing device 1121. The second image output terminal 113 packages the operation code corresponding to the first control signal CS1 into a second control signal CS2 and outputs the second control signal CS2 to the next one in the list, that is, the third display device 12, and the second image output terminal 113 provides the image signal to the third display device 12. The first display device 10, the second display device 11, and the third display device 12 all have the same image signal. Specifically, the second image output terminal 113 provides the second control signal CS2 and the image signal to the third display device 12 through the HDMI signal cable.

The second image input terminal 111 and the second image output terminal 113 are, for example, at least one circuit of the HDMI interface, at least one chip of the HDMI interface, an integrated circuit or at least one chip set of the HDMI interface. The second image and command processing device 112 is, for example, at least one processor, at least one central processing unit (CPU), a graphics processing unit (GPU), other programmable general-purpose or special-purpose microprocessor, a digital signal processor (DSP), a programmable controller, an application specific integrated circuit (ASIC), a programmable logic device (PLD), other at least one of other similar processing chip or circuit, or a combination of these devices. The second command processing device 1120 is, for example, at least one processor, at least one central processing unit (CPU), a graphics processing unit (GPU), other programmable general-purpose or special-purpose microprocessor, a digital signal processor (DSP), a programmable controller, an application specific integrated circuit (ASIC), a programmable logic device (PLD), other at least one of other similar processing chip or circuit, or a combination of these devices. The second image processing device 1121 is, for example, at least one processor, at least one central processing unit (CPU), a graphics processing unit (GPU), other programmable general-purpose or special-purpose microprocessor, a digital signal processor (DSP), a programmable controller, an application specific integrated circuit (ASIC), a programmable logic device (PLD), other at least one of other similar processing chip or circuit, or a combination of these devices. The second displayer 114 of the second display device 11 is, for example, light-emitting diode (LED) displayers, organic light-emitting diode (OLED) displayers, plasma display panel (PDP) displayers, light-emitting diode (LED) panels, or organic light-emitting diode (OLED) panels, etc.

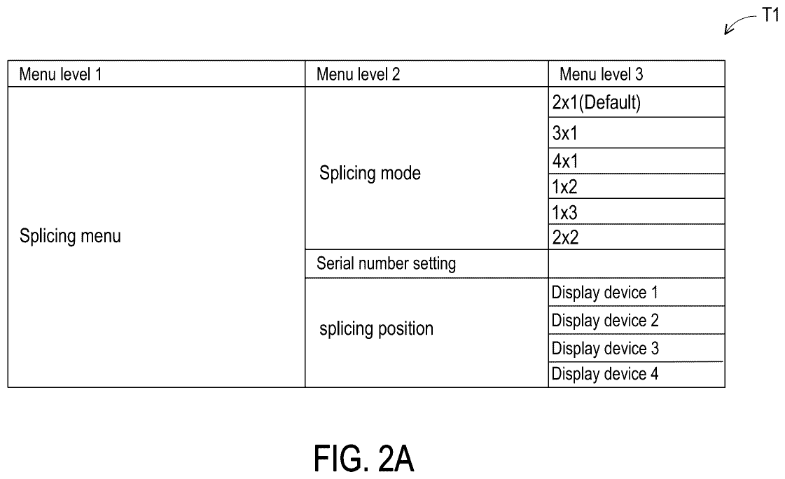

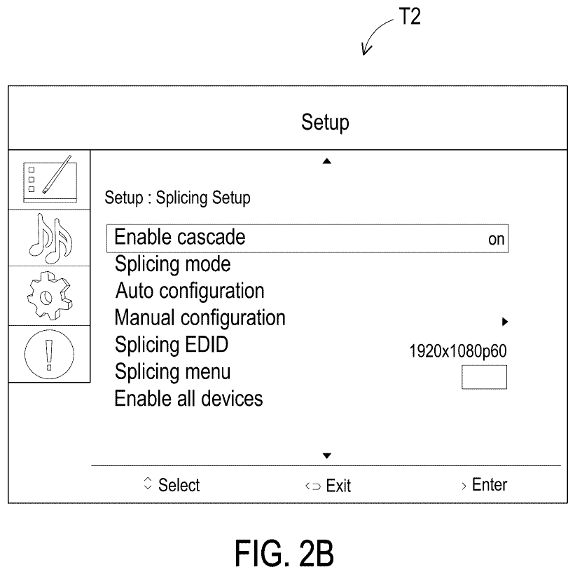

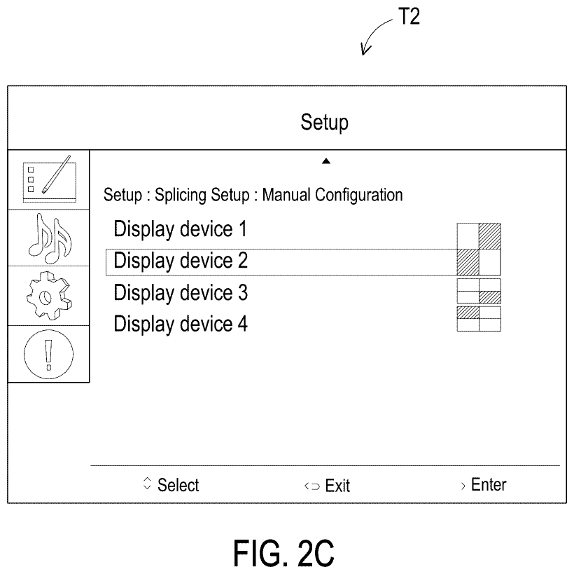

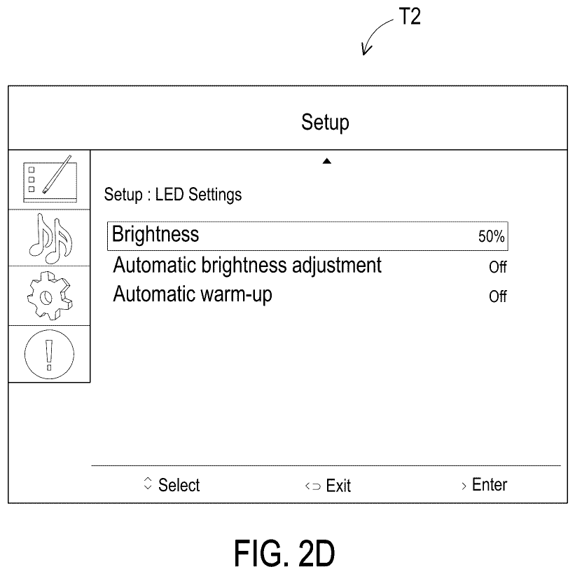

In addition, in order to correctly set each display device in the display system 1 to display a complete predetermined displaying image, the display system 1 receives the first command CMD1 input by the user to set each display device, and the first display device 10 may receive the first command CMD1 through various methods. In one embodiment, the receiver 100 is, for example, an RS232 interface or input device. The user may control the on-screen display (OSD) of the first display device 10 to generate the first command CMD1 through the operation of an input device (e.g., a keyboard, mouse, touch screen, or other suitable input device) connected to the first display device 10 through RS232, UART, USB, or other wired or wireless methods. In one embodiment, the user may also operate an electronic device (computer) or input device connected to the first display device 10 in a wired or wireless method, and directly issue the string of the first command CMD1 to control the first display device 10. In one embodiment, the receiver 100 may be a pluggable device that may be electrically connected to the first display device 10 so that the first display device 10 becomes the master display device. FIG. 2A is a schematic diagram of the functional hierarchy of a window interface displayed on a screen of an embodiment of the disclosure. Specifically, the window interface T1 is, for example, an on-screen display, which may be displayed on the first displayer 104 of the first display device 10. As shown in the window interface T1 in FIG. 2A, after selecting to enter the window interface at menu level 1, the user may select from splicing mode setting, serial number setting or splicing position setting in menu level 2. Specifically, the content of the splicing mode setting refers to the method to cut the image. Therefore, in the splicing mode, menu level 3 displays various options for image cutting methods, each option being designated by a splicing mode number corresponding to the number of rows and columns in image cutting. The splicing mode number is, for example, cutting the image into 2×1, 3×1, 4×1, 1×2, 2×2, . . . , 3×3, etc. or other suitable cutting methods. In addition, the content of the serial number setting is related to determining the order of each display device in the list, and performing numbering accordingly. Finally, the splicing position setting is related to each display device determining which portion of the predetermined displaying image is to be displayed. Therefore, options for each display device may be seen at menu level 3 of the splicing position. The above-mentioned splicing mode setting is, for example, the setting of the splicing mode number, and the splicing position setting is, for example, the setting of the splicing position number.

FIG. 2B to FIG. 2D are schematic diagrams of multiple levels in a window interface T2 displayed on a screen of an embodiment of the disclosure. In FIG. 2B, the menu level 2 of the window interface T2 is displayed, which indicates that the user has selected the window interface (having selected menu level 1 as shown in FIG. 2A) and proceeded to, for example, menu level 2 as shown in FIG. 2A. Consequently, various functions such as “Enable cascade”, “Splicing mode”, and “Manual configuration” of splicing position are displayed.

FIG. 2C illustrates, for example, the content displayed on the window interface T2 after the user selects the function of manual configuration of splicing position in FIG. 2B, corresponding to menu level 3 under the splicing position in FIG. 2A. As shown in FIG. 2C, according to the currently set splicing mode, a corresponding number of display devices is provided in the window interface T2 for the user to set their respective positions to be displayed in the predetermined displaying image. Specifically, when the splicing mode is set to 2×2 (splicing mode number), the window interface T2 provides four display devices (display device 1, display device 2, display device 3, and display device 4) for users to configure. For example, the user may select the display device 2 to display the lower left image of the predetermined displaying image. The user may select the desired display position of the predetermined displaying image on the right side of the corresponding field for each display device.

Additionally, in addition to the splicing mode, serial number setting and splicing position listed in the window interface T1 of FIG. 2A, the first display device 10 may also provide other functions in the on-screen display for the user to select and operate. For example, the contents displayed in the window interface T2 in FIG. 2B also include options such as “Auto configuration”, “extended display identification data”, “turn on all display devices”, and “display serial number of all display devices”. In addition, FIG. 2C also shows that the window interface T2 may include a brightness adjustment function. As shown in FIG. 2C, the user may adjust the brightness of each display device in the list by operating the window interface T2, and transmit the first control signal CS1 generated by the operation of the window interface T2 from the master display device 10 to each slave display device in sequence through the HDMI signal cable.

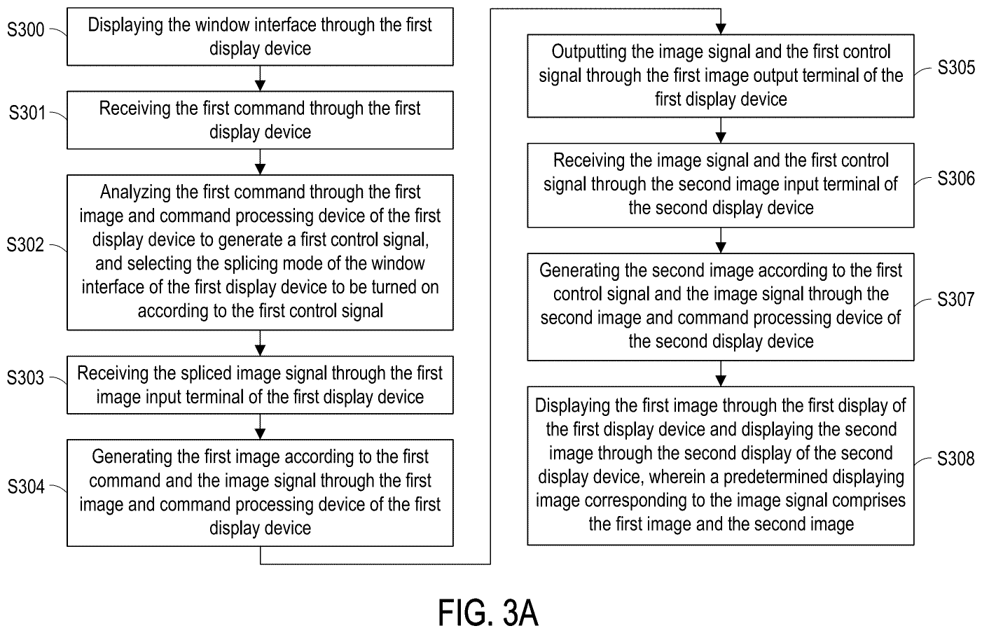

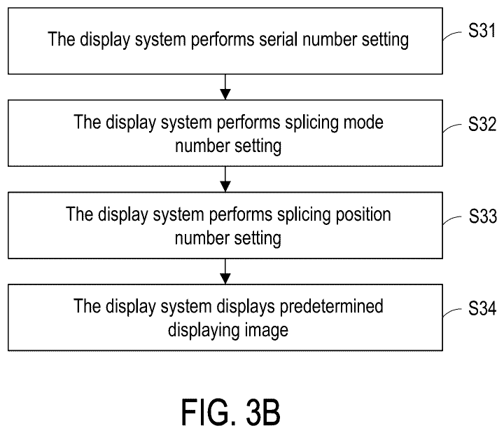

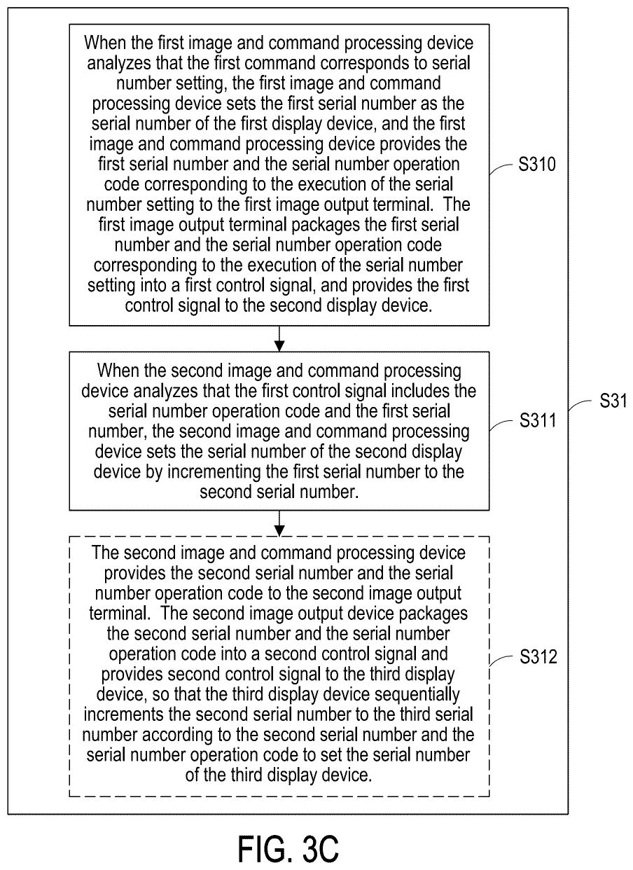

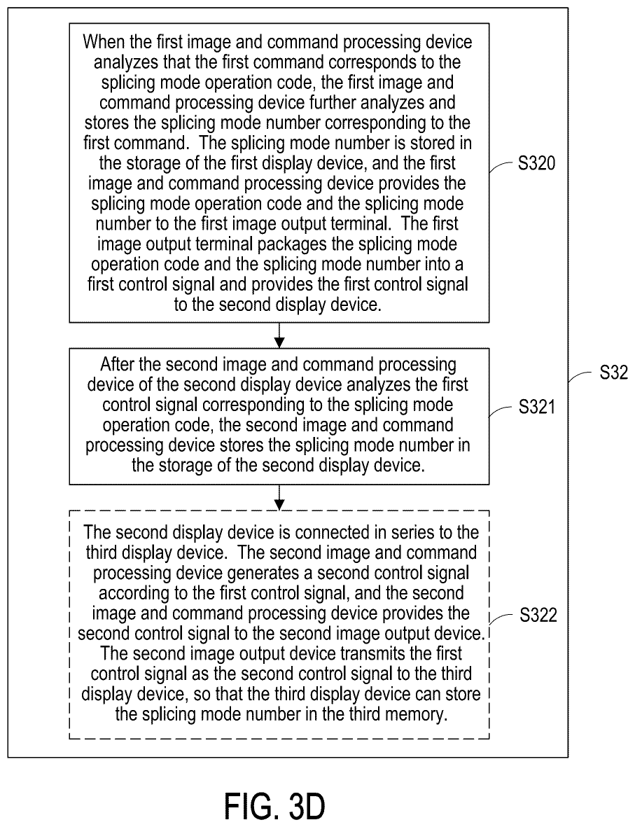

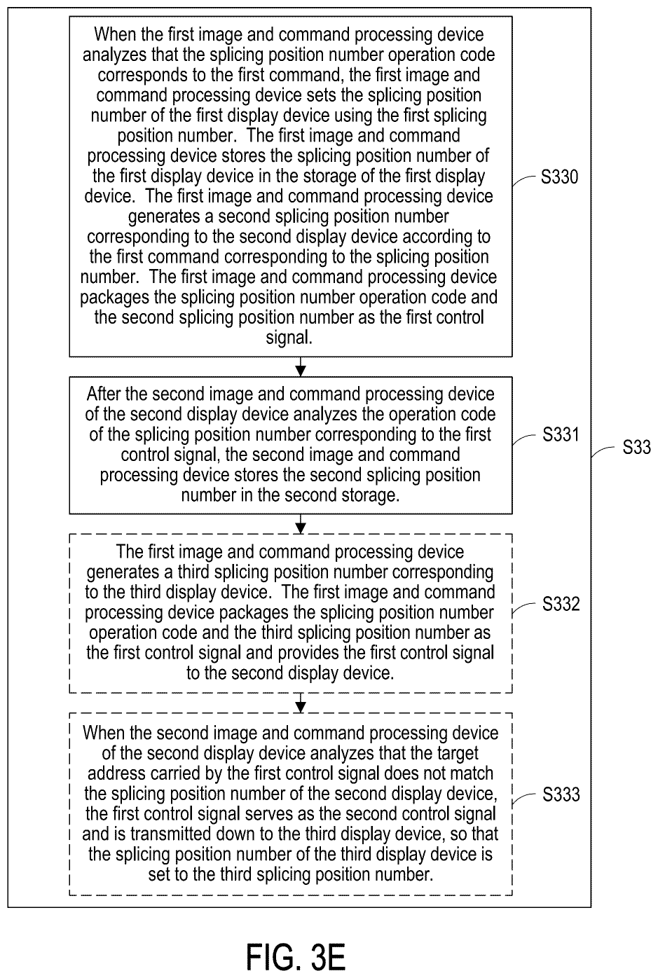

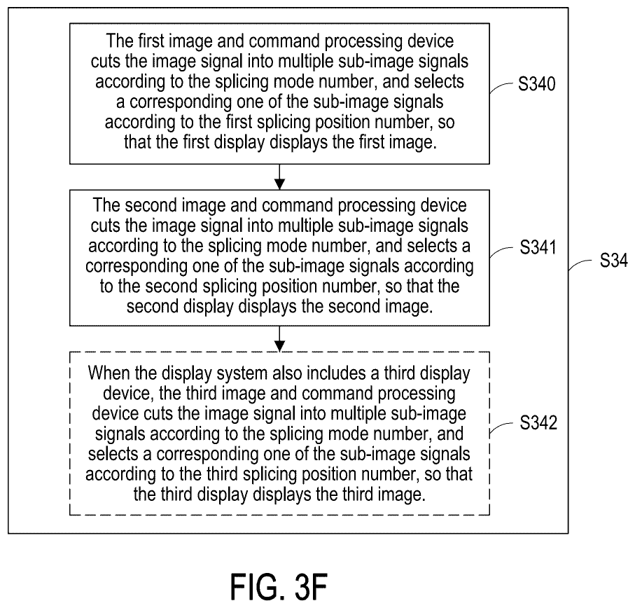

FIG. 3A is a flowchart of a display method of an embodiment of the disclosure. The display method shown in FIG. 3A may be applied to the display system 1 of FIG. 1A. The display method includes steps S300 to S308. Generally speaking, the display method of FIG. 3A describes a process of forming the predetermined displaying image, where the display system 1 receives the first command CMD1, generates the first control signal CS1 after analysis by the first display device 10, and provides the first control signal CS1 to the second display device 11, so that the first display device 10 displays a portion of the predetermined displaying image, and the second display device 11 displays the other portion of the predetermined displaying image to form the predetermined displaying image. In FIG. 3A, the display system 1 includes a first display device 10 and a second display device 11 as an example. In this embodiment, the operation of the display system 1 is to control the first display device 10 and the second display device 11 through the first command CMD1 to display the predetermined displaying image in 1×2 or 2×1, but the disclosure is not limited thereto. Those skilled in the art may naturally modify and extend the display method shown in FIG. 3A to apply it in the operation process of displaying a predetermined displaying image with the participation of additional display devices.

In step S300, the first display device 10 as the main display device may display the window interface through the display of the first display device 10.

In step S301, the first display device 10 may receive the first command CMD1 generated by the user operating the window interface.

In step S302, the first image and command processing device 102 of the first display device 10 may analyze the first command CMD1 to generate the first control signal CS1, and the splicing mode of the window interface of the first display device 10 is selected to be turned on according to the first control signal CS1. Specifically, when the first image and command processing device 102 analyzes the first command CMD1 and the enable cascade function in the window interface is selected, the first image and command processing device 102 may select the splicing mode of the window interface of the first display device 10 to be turned on.

In step S303, the first image input terminal 101 of the first display device 10 may receive an image signal provided from an external image source, that is, a complete predetermined displaying image to be displayed by the entire display system 1. The predetermined displaying image corresponds to the image signal.

In step S304, the first image and command processing device 102 of the first display device 10 may generate the first image according to the first command CMD1 and the image signal. Specifically, the first image and command processing device 102 may cut multiple sub-image signals according to the operation code corresponding to the first command CMD1 and select a first sub-image signal from the multiple sub-image signals to form the first image. The first image corresponds to the first sub-image signal.

In step S305, the first image output terminal 103 of the first display device 10 may output the image signal and the first control signal CS1.

In step S306, the second image input terminal 111 of the second display device 11 may receive the image signal and the first control signal CS1.

In step S307, the second image and command processing device 112 of the second display device 11 generates a second image according to the first control signal CS1 and the image signal. Specifically, the second image and command processing device 112 may cut multiple sub-image signals according to the operation code corresponding to the first control signal CS1 and select a second sub-image signal from the multiple sub-image signals to form the second image. The second image corresponds to the second sub-image signal. The first sub-image signal is different from the second sub-image signal.

In step S308, the first image is displayed through the first displayer 104 of the first display device 10 and the second image is displayed through the second displayer 114 of the second display device 11. A predetermined displaying image corresponding to the image signal comprises the first image and the second image.

In this way, the display system 1 allows the user to operate through the display window interface, thereby generating the first command CMD1 to better control the first display device 10 and the second display device 11 to display the predetermined displaying image.

FIG. 3B is a flowchart of a display method of an embodiment of the disclosure. The display method of FIG. 3B may be executed by the display system 1 of FIG. 1A. Specifically, FIG. 3B describes in more detail how the first control signal CS1 is generated and analyzed in the display system 1 to realize the splicing image operation of the display system 1. The display method of FIG. 3B includes steps S31 to S34.

In step S31, the display system 1 first performs serial number setting so that each display device in the list is numbered. In step S32, the display system 1 performs the splicing mode number setting, that is, each display device in the display system 1 is informed on how the predetermined displaying image is cut. In step S33, the display system 1 performs the splicing position number setting. The splicing position number corresponds to the display position of the display. That is, in this step, the display positions of all or at least a portion of the display devices in the predetermined displaying image are set automatically or manually. Finally, according to the above settings in steps S31 to S33, in step S34, each display device in the display system 1 may individually display the respective sub-display image (e.g., the first image and the second image) according to the settings, and the complete predetermined displaying image is displayed. The predetermined displaying image comprises the first image and the second image

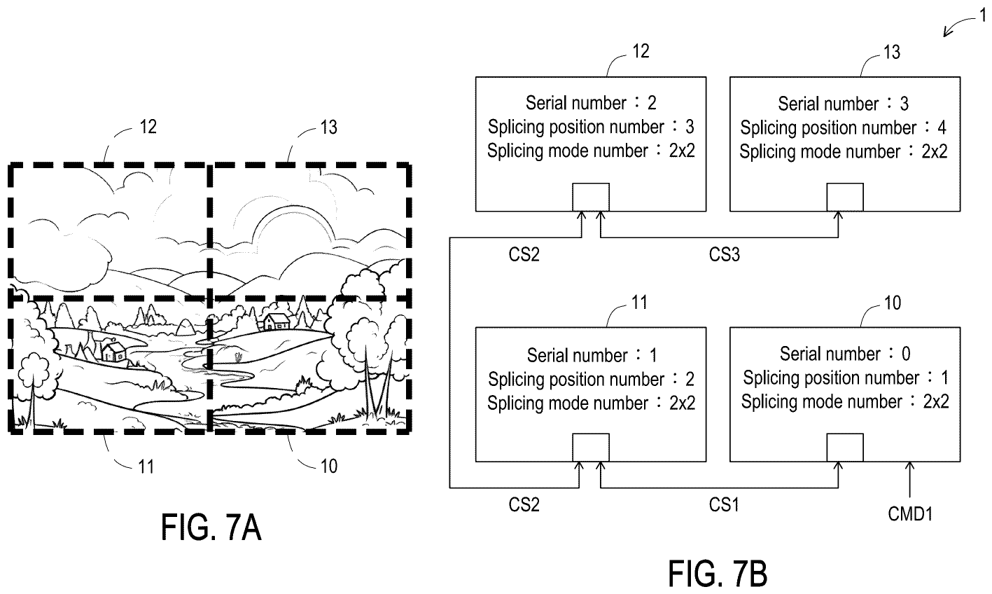

FIG. 3C is a detailed flowchart of step S31 in FIG. 3B. Step S31 includes steps S310 to S312. Specifically, in step S310, when the first image and command processing device 102 analyzes that the first command CMD1 corresponds to the serial number setting, the first image and command processing device 102 may set the first serial number (No. 0, as shown in FIG. 7B) as the serial number of the first display device 10, and the first image and command processing device 102 provides the first serial number and the serial number operation code corresponding to the execution of the serial number setting to the first image output terminal 103. The first image output terminal 103 packages the first serial number and the serial number operation code corresponding to the execution of the serial number setting into the first control signal CS1, and provides the first control signal CS1 to the second display device 11. In step S311, when the second image and command processing device 112 analyzes that the first control signal CS1 includes the serial number operation code and the first serial number, the second image and command processing device 112 sets the serial number of the second display device 11 by incrementing the first serial number to the second serial number. That is, the numbering is continued by adding 1 to the serial number. In some cases, when the display system 1 has a third display device 12 connected in series, step S312 in step S31 is executed. In step S312, the second image and command processing device 112 provides the second serial number and the serial number operation code to the second image output terminal 113. The second image output terminal 113 packages the second serial number and the serial number operation code into a second control signal CS2 and provides the second control signal CS2 to the third display device 12, so that the third display device 12 sequentially increments the second serial number to the third serial number according to the second serial number and the serial number operation code to set the serial number of the third display device 12. The above-mentioned respective serial numbers are respectively stored in the storage of respective display devices.

FIG. 3D is a detailed flowchart of step S32 in FIG. 3B. Step S32 includes steps S320 to S322. In step S320, in the splicing mode setting, the user selects a splicing mode number, such as 2×1. When the first image and command processing device 102 analyzes that the first command CMD1 corresponds to the splicing mode operation code, the first image and command processing device 102 further analyzes and stores the splicing mode number corresponding to the first command CMD1. The splicing mode number is stored in the storage of the first display device 10, and the first image and command processing device 102 provides the splicing mode operation code and the splicing mode number to the first image output terminal 103. The first image output terminal 103 packages the splicing mode operation code and the splicing mode number into the first control signal CS1 and provides the first control signal CS1 to the second display device 11. In step S321, after the second image and command processing device 112 of the second display device 11 analyzes and obtains the splicing mode operation code corresponding to the first control signal CS1, the second image and command processing device 112 stores the splicing mode number in the storage of the second display device 11. In addition, in step S322, when the second display device 11 is also connected to a third display device 12 in series, the second image and command processing device 112 generates the second control signal CS2 according to the first control signal CS1. The second image and command processing device 112 provides the second control signal CS2 to the second image output terminal 113. The second image output terminal 113 transmits the first control signal CS1 as the second control signal CS2 to the third display device 12 so that the third display device 12 may store the splicing mode number in the third storage. In the above step S32, the control signal is transmitted to the last display device in the list in the display system 1.

FIG. 3E is a detailed flowchart of step S33 in FIG. 3B. Step S33 includes steps S330 to S333. In step S330, as shown in FIG. 2A, in the case of the splicing position setting, when the first image and command processing device 102 analyzes the splicing position number operation code corresponding to the first command CMD1, the first image and command processing device 102 sets the first splicing position number (No. 1, as shown in FIG. 7B) as the splicing position number of the first display device 10. The first image and command processing device 102 stores the splicing position number of the first display device 10 in the storage of the first display device 10. The first image and command processing device 102 generates a second splicing position number (No. 2) corresponding to the second display device 11 according to the splicing position number corresponding to the first command CMD1. The first image and command processing device 102 packages the splicing position number operation code and the second splicing position number into the first control signal CS1. In step S331, after the second image and command processing device 112 of the second display device 11 analyzes the splicing position number operation code corresponding to the first control signal CS1, the second image and command processing device 112 stores the second splicing position number in the second storage. In addition, in step S332, when the third display device 12 is also connected in series in the list of the display system 1, the first image and command processing device 112 also generates a third splicing position number corresponding to the third display device 12. The first image and command processing device 112 packages the splicing position number operation code and the third splicing position number into the first control signal CS1 and provide the first control signal CS1 to the second display device 11. In step S333, when the second image and command processing device 112 of the second display device 11 analyzes that the target address carried by the first control signal CS1 does not match the splicing position number of the second display device 11, the first control signal CS1 serves as the second control signal CS2 and is transmitted onwards to the third display device 12, so that the splicing position number of the third display device 12 is set to the third splicing position number. The above splicing position number setting may be automatic or manual. When the splicing position number setting is automatic, the splicing position number generated by the first image and command processing device 112 corresponds to the order of the serial number of each display device, and the first control signal CS1 is sent to each display device. When the splicing position number setting is manual, the splicing position number generated by the first image and command processing device 112 may be specified by the user, and the first control signal CS1 sent is only received by the specific display device selected by the user.

FIG. 3F is a detailed flowchart of step S34 in FIG. 3B. Step S34 includes steps S340 to S342. In step S340, the first image and command processing device 102 cuts the image signal into multiple sub-image signals according to the splicing mode number (the splicing mode operation code has a splicing mode number), and selects a corresponding one of the sub-image signals according to the first splicing position number, so that the first displayer 104 displays the first image. In step S341, similarly, the second image and command processing device 112 also cuts the image signal into multiple sub-image signals according to the splicing mode number, and selects a corresponding one of the sub-image signals according to the second splicing position number, so that the second displayer 114 displays the second image. In step S342, when the display system 1 also includes a third display device 12, the third image and command processing device 122 also cuts the image signal into multiple sub-image signals according to the splicing mode number, and selects a corresponding one of the sub-image signals according to the third splicing position number, so that the third display displays the third image. The above operation of cutting the predetermined displaying image and displaying the sub-image signal corresponding to the splicing position number is executed by each image and command processing device in the display system 1. That is, each display device has the same image signal. The image and command processing device of each display device cuts the image signal into multiple sub-image signals. The corresponding sub-image signal may be selected according to the splicing position number of the respective display device, and then the sub-image signal is transmitted to the respective display to display the sub-image.

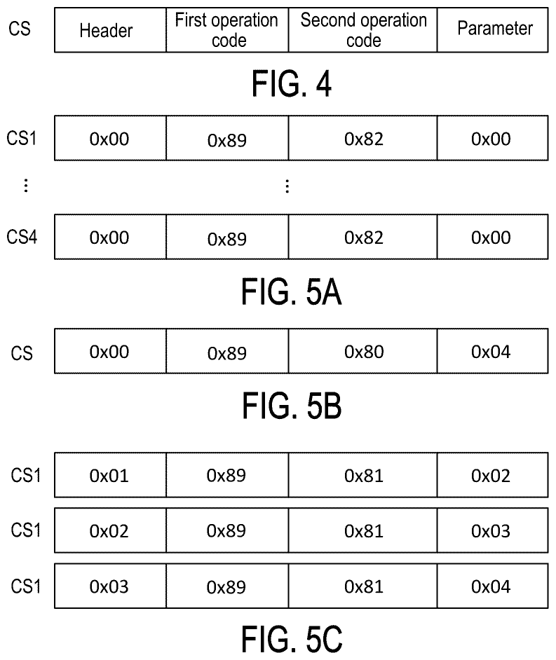

FIG. 4 is a schematic diagram of fields of a control signal of an embodiment of the disclosure. Specifically, the control signal CS may be, for example, the first control signal CS1 and the second control signal CS2 in FIG. 1A. Since the control signal CS is transmitted through the HDMI signal cable, the control signal CS is a signal that complies with the consumer electronics control (CEC) functionality under the high definition multimedia interface (HDMI) specifications. Specifically, CEC signals that comply with the HDMI specification have multiple fields. The first field is the header field, which carries the destination address and originating address of the signal. The second field will be the operation code field, and the operation code it carries may indicate the operation type of the signal or related information. Subsequent fields are data fields.

In this embodiment, as a CEC signal that complies with the HDMI specification, the control signal CS has four fields. The first field is the header field, the second field is the first operation code field, the third field is the second operation code field, and the fourth field is the parameter field, which records the relevant parameters of the execution operation.

Specifically, the first field of the control signal CS includes the target address of the recipient to whom the control signal CS is to be transmitted.

Regarding the second field of the control signal CS, as a CEC signal that complies with the HDMI specification, since CEC 1.4 and CEC 2.0 have partially defined the operation code of this field, the first operation code carried in the second field of the control signal CS must comply with the CEC 1.4 and CEC 2.0 protocols. In some embodiments, the first operation code (also referred to as the control signal operation code) carried in the second field of the control signal CS may be, for example, a control code 0×89 reserved for a specific vendor (vendor command), or an operation code that is reserved and undefined in the CEC 1.4 and CEC 2.0 protocols.

Regarding the third field of the control signal CS, it may carry a custom operation code indicating the operation to be performed on the control signal CS.

Finally, regarding the fourth field of the control signal CS, it may carry relevant parameters regarding the custom operation code carried in the third field.

FIG. 5A is a schematic diagram of control signals CS1-CS4 carrying serial number operation code of an embodiment of the disclosure. Next, please refer to step S30 of FIG. 3B and FIG. 5A to understand the following description of the control signals CS1 to CS4 used to command the serial number operation. In this example, the display system 1 may have, for example, four display devices connected in series (first display device 10 to fourth display device 13), and the display system 1 is set to a splicing mode number of 2×2.

Specifically, when the first image and command processing device 102 analyzes that the received first command CMD1 corresponds to the serial number setting, as shown in the first row of FIG. 5A, the first image and command processing device 102 may control the first image output terminal 103 to carry address information such as 0×00 in the first field of the output first control signal CS1, indicating that the first control signal CS1 may be a broadcast control signal, and the recipient may be each display device on the list. The operation code of the first control signal CS1 is, for example, the second field and the third field. For example, the first control signal CS1 may respectively carry the operation code 0×89 corresponding to the splicing operation and the customized operation code 0×82 in the second field and the third field, corresponding to the serial number operation code of the serial number setting for the display system 1. Finally, the fourth field carries the current serial number 0×00 of the first display device 10.

In this way, when the second display device 11 receives the first control signal CS1, the second display device 11 may analyze the first field of the first control signal CS1 through the second image and command processing device 112 to determine whether the second display device 11 is the recipient of the first control signal CS1. When the determination result is “yes”, the second image and command processing device 112 may analyze the second field of the first control signal CS1 to determine the type of the first control signal CS1. When it is analyzed that the second field carries the first operation code 0×89 (also referred to as the first control signal operation code), the second image and command processing device 112 may determine that the type of the first control signal CS1 is a customized control signal, therefore the third field and the fourth field may then be analyzed. When the second image and command processing device 112 analyzes that the third field and the fourth field respectively carry the custom operation code 0×82 and the parameter of 0×00, the second image and command processing device 112 may determine that the command of the first control signal CS1 is to perform the serial number setting. Therefore, the second image and command processing device 112 may increment the serial number (i.e., the parameter carried in the fourth field) carried in the first control signal CS1 to 1 and set it as the serial number of the second display device 11, thus completing the serial number setting.

Furthermore, since in this example, the third display device 12 is connected in series after the second display device 11, the second image and command processing device 112 may update the fourth field of the first control signal CS1 with its own serial number while the first three fields of the first control signal CS1 remain unchanged, and generate the second control signal CS2 and provide the second control signal CS2 to the subsequent third display device 12. By analogy, the display devices in the list receive control signals with sequentially increasing serial numbers, therefore the display devices are informed on their own order in the list, and the serial number setting of the overall display system 1 is completed. In some embodiments, after the last display device completes its own serial number setting, the last display device returns the serial number that is the last one in the list to the first display device 10, so that the first display device 10 is informed on the total number of display devices in the list.

FIG. 5B is a schematic diagram illustrating a control signal carrying splicing mode operation code of an embodiment of the disclosure. Next, please refer to step S31 of FIG. 3B and FIG. 5B to understand the following description of the control signals CS1 to CS4 used to command the splicing mode setting.

Specifically, when the first image and command processing device 102 analyzes that the received first command CMD1 corresponds to the splicing mode setting, as shown in FIG. 5B, the first image and command processing device 102 may control the first image output terminal 103 to carry address information such as 0×00 in the first field of the output first control signal CS1, indicating that the first control signal CS1 may be a broadcast control signal, and the recipient may be each display device on the list. Moreover, the first control signal CS1 may respectively carry the operation code 0×89 corresponding to the splicing operation and the customized operation code 0×80 in the second field and the third field, corresponding to the splicing mode setting for the display system 1. Finally, the fourth field carries the splicing mode number 0×04 currently set for the display system 1, which, for example, corresponds to display in the 2×2 splicing mode.

Since all the display devices in the list are set in the same splicing mode (with the same splicing mode number), when the second image and command processing device 112 analyzes that the received first control signal CS1 corresponds to the splicing mode setting, the first control signal CS1 is directly transmitted as the second control signal CS2 to the subsequent third display device 12 through the first image output terminal 103. In this way, each display device transmits the same control signal onwards during the splicing mode setting, so that each display device may be set in the same splicing mode.

FIG. 5C is a schematic diagram illustrating a first control signal carrying splicing position number operation code of an embodiment of the disclosure. Next, please refer to step S33 of FIG. 3B and FIG. 5C to understand the following description of the first control signal CS1 used to command the splicing position number setting.

Specifically, when the first image and command processing device 102 analyzes that the received first command CMD1 corresponds to the splicing position number setting, as shown in FIG. 5C, the first image and command processing device 102 may control the first image output terminal 103 to carry address information such as 0×01 in the first field of the output first control signal CS1, indicating that the recipient of the first control signal CS1 may be the second display device 11 with serial number 1 on the list. Moreover, the first control signal CS1 may respectively carry the operation code 0×89 corresponding to the splicing operation and the customized operation code 0×81 in the second field and the third field, corresponding to the splicing position number setting for the display system 1. Finally, the fourth field carries the splicing position number to which the second display device 11 is to be set.

When the second display device 11 analyzes that the target address carried in the first field of the first control signal CS1 matches its own serial number, then the second and third fields may be analyzed to determine that the first control signal CS1 is to command the splicing position number setting. Furthermore, the second display device 11 may determine that the splicing position number of the second display device 11 is to be set to 2 according to the fourth field.

Then, by analogy, the first image and command processing device 102 may also send the first control signal CS1 as shown in the second and third rows of FIG. 5C, whose target addresses are 0×02 and 0×03 respectively, and the parameter values are 0×03 and 0×04 respectively, indicating that the splicing position numbers of the third display device 12 and the fourth display device 13 are to be set to 3 and 4 respectively.

In some embodiments, the above-mentioned operation of the splicing position number setting may be in response to the first command CMD1 generated from the user operating the window interface as shown in FIG. 2C and selecting a function for automatically setting the splicing position numbers of all display devices in the control display system 1. That is, when the user selects the option of automatically setting the splicing position number, the first display device 10 sends multiple first control signals CS1 and transmits the first control signals CS1 to each display device in the display system 1 in sequence to set the splicing position number. In some embodiments, the setting of the splicing position number may be manually performed by the user for each display device. That is, every time the user sets the splicing position number for a specific display device, the first display device 10 sends the corresponding first control signal CS1 accordingly to set the splicing position number of the specific display device, in which the specific display device is the display device selected by the user.

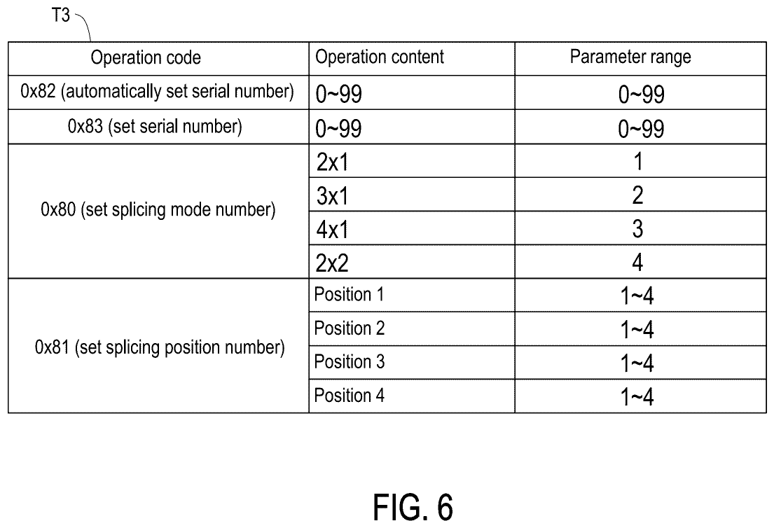

FIG. 6 is a schematic diagram of a table of second operation code of an embodiment of the disclosure. As shown in Table T3, the second operation codes 0×82 and 0×83 correspond to the serial number setting and are used to set the serial number according to the parameter value in the control signal. In addition, the second operation code 0×80 corresponds to the splicing mode number setting, and different parameters correspond to different splicing methods in the display system 1. Finally, the second operation code 0×81 corresponds to the splicing position number setting, that is, this setting determines which position of the predetermined displaying image the display device displays, and different parameters correspond to different positions in the predetermined displaying image.

FIG. 7A and FIG. 7B are schematic diagrams of a display system displaying a predetermined displaying image of an embodiment of the disclosure. Specifically, as shown in FIG. 7B, after completing the above-mentioned operations of steps S31 to S33, the first display device 10 to the fourth display device 13 may store the corresponding serial number, splicing position number, and splicing mode number. Therefore, after the image signal is cut into multiple sub-image signals, each display device may select the corresponding sub-image signal according to its own splicing position number. The selected sub-image signal is then transmitted to the display of the respective display device to display the sub-image. Therefore, the sub-display images respectively displayed by each display device may be spliced together to form a complete predetermined displaying image as shown in FIG. 7A.

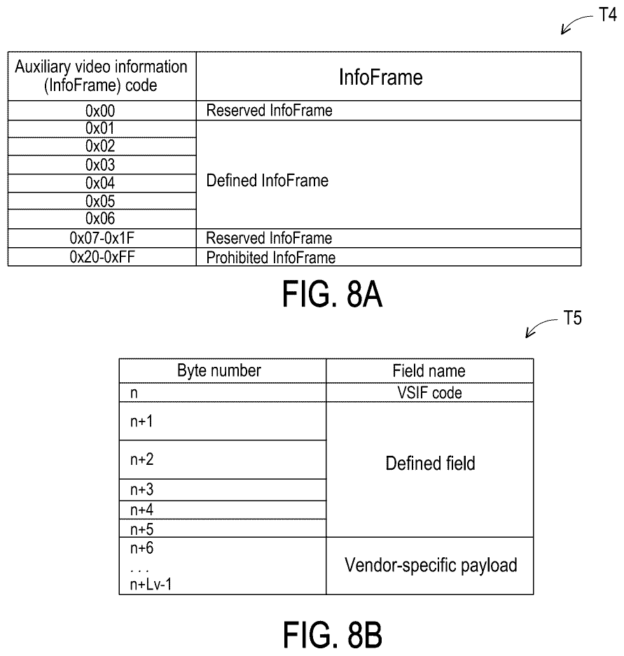

FIG. 8A is a schematic diagram of a table of InfoFrame code of an embodiment of the disclosure. Specifically, in Table T4, the control signal CS in the display system 1 may be transmitted through an HDMI signal cable as a CEC signal that complies with the HDMI specification. The control signal CS may also be packaged in a vendor-specific payload or reserved field in the auxiliary video information (InfoFrame) of the high definition multimedia interface. Furthermore, when HDMI format signals are transmitted, in addition to transmitting image signals, other auxiliary video information related to the display will also be transmitted. Therefore, the control signal CS may also be packaged in the auxiliary fields of these auxiliary video information or in the reserved field. Specifically, FIG. 8A lists various InfoFrame and their corresponding InfoFrame code. Specifically, the InfoFrame code 0×00, 0×07-0×1F belong to reserved InfoFrame, and the display system 1 may transmit under these reserved InfoFrame. Alternatively, the InfoFrame code 0×01-0×06 are defined InfoFrame, in which the InfoFrame code 0×01 belongs to vendor specific InfoFrame (VSIF), while 0×02 to 0×06 are InfoFrame in other defined field formats. The control signal CS may be transmitted in VSIF, or in a reserved field in other defined InfoFrame.

FIG. 8B is a schematic diagram of a table of each field in a VSIF of an embodiment of the disclosure. As shown in FIG. 8B, in the fields of Table 5, there are multiple fields in VSIF. The control signal CS described above in relation to FIG. 4 and FIG. 5A to FIG. 5C may also be packaged in the vendor specific payload after n+6 (n is the byte number), and the VSIF code 0×01 may also be stored in the field of the nth byte field for identification. Of course, as mentioned above, the control signal CS may also be packaged and transmitted in reserved fields in other defined InfoFrame (i.e., the InfoFrame code 0×02-0×06 in FIG. 8A).

To sum up, the display system and display method of the disclosure have at least one of the following advantages: control signals and the image signal may be transmitted between multiple display devices through at least one HDMI signal cable connected in series to achieve splicing of the predetermined displaying image, and the splicing setting of the display system may be controlled through the window interface, thus effectively avoiding the complicated hardware settings of conventional display systems and the complicated operating procedures of conventional display methods.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A display system, comprising:
a first display device, comprising:
a first image and command processing device, configured to generate a first control signal;
a first image input terminal, configured to receive an image signal, wherein the image signal corresponds to a predetermined displaying image;
a first displayer; and
a first image output terminal, configured to output the image signal and the first control signal, wherein the first image and command processing device is electrically connected to the first image input terminal, the first displayer, and the first image output terminal;
a first transmission cable, configured to transmit the image signal and the first control signal from the first display device to the second display device; and
a second display device, connected to the first display device through the first transmission cable, wherein the second display device comprises:
a second image and command processing device;
a second image input terminal, connected to the first image output terminal through the first transmission cable and configured to receive the image signal and the first control signal;
a second displayer; and
a second image output terminal, wherein the second image and command processing device is electrically connected to the second image input terminal, the second displayer, and the second image output terminal, wherein when the first displayer is configured to display a window interface, a splicing mode of the window interface is selected to be turned on so as to generate a first command by the first display device, the first display device is configured to generate the first control signal according to the first command and transmit the first control signal to the second display device, wherein the first displayer of the first display device is configured to display a first image and the second displayer of the second display device is configured to display a second image, wherein the predetermined displaying image comprises the first image and the second image.

2. The display system according to claim 1, wherein the first control signal is a signal that complies with a control function of a consumer electronic product under a high definition multimedia interface.

3. The display system according to claim 1, wherein the first control signal is a vendor-specific payload or a reserved field packaged in auxiliary video information of a high definition multimedia interface.

4. The display system according to claim 1, wherein when the first image and command processing device is configured to analyze that the first command corresponds to a serial number operation code, the first image and command processing device is configured to set a serial number of the first display device using a first serial number, and the first image and command processing device is configured to provide the first serial number and the serial number operation code to the first image output terminal, the first image output terminal is configured to package the first serial number and the serial number operation code into the first control signal,
wherein when the second image and command processing device analyzes that the first control signal comprises the serial number operation code, the second image and command processing device is configured to set a serial number of the second display device by incrementing the first serial number to the second serial number.

5. The display system according to claim 4, further comprising a third display device connected in series to the second display device,
wherein the second image and command processing device is configured to provide the second serial number and the serial number operation code to the second image output terminal, the second image output terminal is configured to package the second serial number and the serial number operation code into a second control signal and provide the second control signal to the third display device, so that the third display device is configured to sequentially increment the second serial number to the third serial number according to the second serial number and the serial number operation code to set a serial number of the third display device.

6. The display system according to claim 5, wherein the first display device further comprises a first storage, the second display device further comprises a second storage, when the first image and command processing device analyzes that the first command corresponds to a splicing mode operation code, the first image and command processing device is configured to further analyze and store a splicing mode number carried by the first command in the first storage, and the first image and command processing device is configured to provide the splicing mode operation code and the splicing mode number to the first image output terminal, the first image output terminal is configured to package the splicing mode operation code and the splicing mode number into the first control signal and provide the first control signal to the second display device,
wherein after the second display device analyzes that the first control signal corresponds to the splicing mode operation code, the second image and command processing device is configured to store the splicing mode number in the second storage.

7. The display system according to claim 6, further comprising the third display device connected in series to the second display device, the third display device further comprising a third storage,
wherein the second image and command processing device is configured to control the second image output terminal to transmit the first control signal as the second control signal to the third display device, so that the third display device stores the splicing mode number in the third storage.

8. The display system according to claim 6, wherein when the first image and command processing device analyzes that the first command corresponds to splicing position number operation code, the first image and command processing device is configured to set a splicing position number of the first display device using a first splicing position number, the first image and command processing device is configured to generate a second splicing position number corresponding to the second display device, the first image and command processing device is configured to package the splicing position number operation code and the second splicing position number into the first control signal,
wherein after the second display device analyzes that the first control signal corresponds to the splicing position number operation code, the second image and command processing device is configured to store the splicing position number operation code in the second storage.

9. The display system according to claim 8, further comprising the third display device sequentially connected in series to the first display device and the second display device,
wherein the first image and command processing device is configured to further generate a third splicing position number corresponding to the third display device, the first image and command processing device is configured to package the splicing position number operation code and the third splicing position number into the first control signal, and provide the first control signal to the second display device,
when the second display device analyzes that a target address carried by the first control signal does not match the serial number of the second display device, the first control signal serves as the second control signal and is transmitted onwards to the third display device, so that the splicing position number of the third display device is set to the third splicing position number.

10. The display system according to claim 9, wherein the first image and command processing device is configured to cut the image signal into a plurality of sub-image signals according to the splicing mode number, and select one of the sub-image signals according to the first splicing position number, so that the first displayer displays the first image,
the second image and command processing device is configured to cut the image signal into the sub-image signals according to the splicing mode number, and select a corresponding one of the sub-image signals according to the second splicing position number, so that the second displayer displays the second image.

11. A display method, suitable for a display system, the display system comprising a first display device, a first transmission cable, and a second display device, the display method comprising:
displaying a window interface through the first display device;
selecting a splicing mode of the window interface to be turned on for generating a first command;
analyzing the first command through a first image and command processing device of the first display device to generate a first control signal;
receiving an image signal through a first image input terminal of the first display device;
generating a first image according to the first control signal and the image signal through the first image and command processing device of the first display device;
outputting the image signal and the first control signal through the first image output terminal of the first display device;
receiving the image signal and the first control signal through a second image input terminal of the second display device via the first transmission cable;
generating a second image according to the first control signal and the image signal through a second image and command processing device of the second display device;
displaying the first image through a first displayer of the first display device; and
displaying the second image through a second displayer of the second display device, wherein a predetermined displaying image corresponding to the image signal comprises the first image and the second image.

12. The display method according to claim 11, wherein when the first image and command processing device analyzes that the first command corresponds to serial number operation code, the first image and command processing device sets a serial number of the first display device using a first serial number, wherein the first image and command processing device provides the first serial number and the serial number operation code to the first image output terminal, the first image output terminal packages the first serial number and the serial number operation code into the first control signal,
wherein when the second image and command processing device analyzes that the first control signal comprises the serial number operation code, the second image and command processing device sets a serial number of the second display device by incrementing the first serial number to the second serial number.

13. The display method according to claim 12, the display system further comprising a third display device connected in series to the second display device, the display method further comprising:
providing the second serial number and the serial number operation code to the second image output terminal through the second image and command processing device, wherein the second image output terminal packages the second serial number and the serial number operation code into a second control signal and provides the second control signal to the third display device, so that the third display device sequentially increments the second serial number to the third serial number according to the second serial number and the serial number operation code to set a serial number of the third display device.

14. The display method according to claim 13, further comprising:
wherein the first display device comprises a first storage, the second display device comprises a second storage, wherein when the first image and command processing device analyzes that the first command corresponds to splicing mode operation code, the first image and command processing device further analyzes and stores a splicing mode number carried by the first command in the first storage, wherein the first image and command processing device provides the splicing mode operation code and the splicing mode number to the first image output terminal, the first image output terminal packages the splicing mode operation code and the splicing mode number into the first control signal and provides the first control signal to the second display device,
after analyzing that the first control signal corresponds to the splicing mode operation code through the second display device, the second image and command processing device stores the splicing mode number in the second storage.

15. The display method according to claim 14, the display system further comprising the third display device connected in series to the second display device, the third display device comprising a third storage, the display method further comprising:
controlling the second image output terminal to transmit the first control signal as the second control signal to the third display device through the second image and command processing device, so that the third display device stores the splicing mode number in the third storage.

16. The display method according to claim 14, comprising:
wherein when the first image and command processing device analyzes that the first command corresponds to splicing position number operation code, the first image and command processing device sets a splicing position number of the first display device using a first splicing position number, wherein the first image and command processing device generates a second splicing position number corresponding to the second display device, the first image and command processing device packages the splicing position number operation code and the second splicing position number into the first control signal,
after the second display device analyzes that the first control signal corresponds to the splicing position number operation code, the second image and command processing device stores the splicing position number operation code in the second storage.

17. The display method according to claim 16, the display system further comprising the third display device sequentially connected in series to the first display device and the second display device, the display method further comprising:
further generating a third splicing position number corresponding to the third display device through the first image and command processing device, packaging the splicing position number operation code and the third splicing position number into the first control signal through the first image and command processing device, and providing the first control signal to the second display device, and
wherein when the second display device analyzes that a target address carried by the first control signal does not match a serial number of the second display device, the first control signal serves as the second control signal and is transmitted onwards to the third display device, so that the splicing position number of the third display device is set to the third splicing position number.

18. The display method according to claim 17, comprising:
cutting the image signal into a plurality of sub-image signals according to the splicing mode number and selecting one of the sub-image signals according to the first splicing position number through the first image and command processing device, displaying the first image through the first displayer, and
cutting the image signal into the sub-image signals according to the splicing mode number and selecting a corresponding one of the sub-image signals according to the second splicing position number through the second image and command processing device, displaying the second image through the second displayer.
